(19) United States
(12) Patent Application Publication
(10) Pub. No.: US 2013/0219163 A1
(43) Pub. Date: Aug. 22, 2013

(54) SYSTEMS AND METHODS FOR SCHEDULING CHANGES

(71) Applicants: Yaniv Sayers, Petach-Tikva (IL); Edith Ronen, Ramat-Hasharon (IL); Ahi Gvirtsman, Tel-Aviv (IL)

(72) Inventors: Yaniv Sayers, Petach-Tikva (IL); Edith Ronen, Ramat-Hasharon (IL); Ahi Gvirtsman, Tel-Aviv (IL)

(21) Appl. No.: 13/879,443

(22) PCT Filed: Oct. 27, 2010
(86) PCT No.: PCT/US10/54258

§ 371 Date: Apr. 15, 2013

(51) Int. Cl. G06F 9/44

(52) U.S. Cl. CPC G06F 9/44
USPC 713/100

(57) ABSTRACT

The present disclosure includes a system and method for scheduling changes. In an example of scheduling changes according to the present disclosure, a usage pattern of a number of services (104-1, 104-2, 104-N, 236) is determined, a window of time in which the usage pattern includes fewer transactions than the usage pattern during a number of other windows of time is determined (116, 216, 352); and a change (238) during the window of time in which the usage pattern includes fewer transactions than the usage pattern during a number of other windows of time is scheduled (116, 216, 354).

### BACKGROUND

Changing a computing environment can negatively impact the availability and functionality of the services provided in that environment. Such changes may include alterations of hardware, software, and other components within the environment. In one example, a change can include updating a version of a computer program. In another example, a change can be an upgrade to a server on a computer network. Through a change management process, attempts can be made to minimize these negative impacts. To determine a strategy for when and how to implement changes, the change management process analyzes factors affecting the implementation. Change management strategies can be base on an analysis related to the cost of the change to a user and/or a provider of a service, the impact on future use of a service by a user caused by the change, the use of a service by a user during the change, and/or the benefits to a user and/or a provider of a service caused by the change.

### BRIEF DESCRIPTION OF THE DRAWINGS

FIG. 1A is a computing network and change scheduling system according to examples of the present disclosure.

FIG. 1B is a block diagram illustrating an example of a computer readable medium (CRM) in communication with processing resources.

FIG. 2 is a change scheduling relationship diagram illustrating components of a change scheduling system according to examples of the present disclosure.

FIG. 3 is a method flow diagram illustrating change scheduling according to examples of the present disclosure.

### DETAILED DESCRIPTION

The present disclosure includes a system and method for scheduling changes. A method for scheduling changes can include determining a usage pattern of a number of services, determining a window of time in which the usage pattern includes fewer transactions than the usage pattern during a number of other windows of time, and scheduling a change during the window of time in which the usage pattern includes fewer transactions than the usage pattern during a number of other windows of time. The method can further include determining usage patterns of a number of services by collecting and analyzing real user monitoring (RUM) data and determining usage patterns of a number of services by creating a baseline representing the usage pattern of the number of services for a time period. The method can also further include detecting a number of services affected by the change using a configuration management database and implementing the change during the window of time.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice this disclosure, and it is to be understood that other examples may be utilized and that process, electrical, and/or structural changes may be made without departing from the scope of the present disclosure.

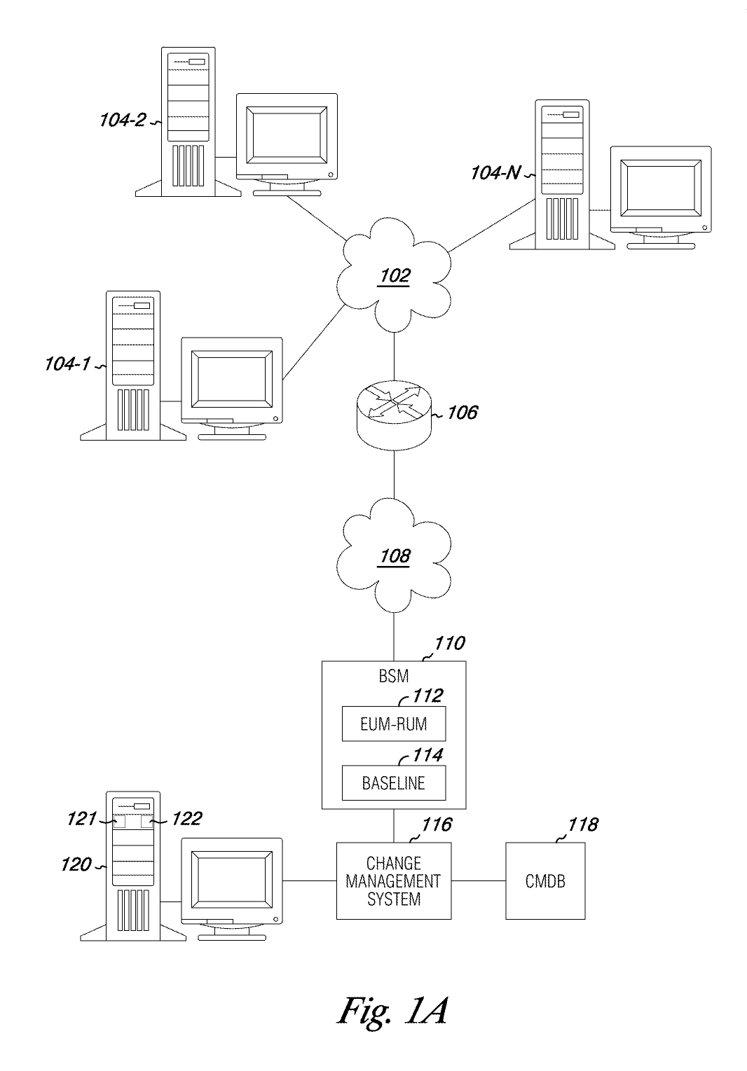

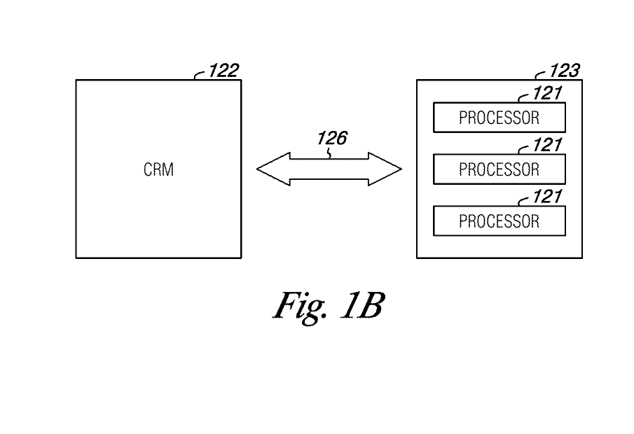

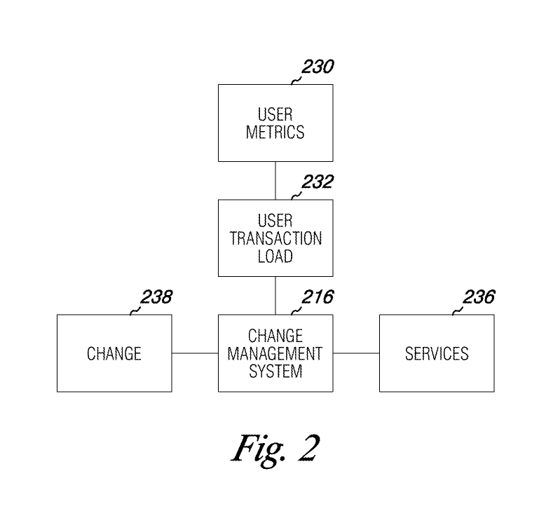

The figures herein follow a numbering convention in which the first digit or digits correspond to the drawing figure number and the remaining digits identify an element or component in the drawing. Similar elements or components between different figures may be identified by the use of similar digits. For example, 116 may reference element “16” in FIG. 1A, and a similar element may be referenced as 216 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

FIG. 1A is a computing network and change scheduling system according to examples of the present disclosure. The computing network system can include a communication network 102 having a number of electronic devices communicatively coupled thereto. As shown in FIG. 1A, communication network 102 can include a number of devices 104-1, 104-2, and 104-N. The number of devices 104-1, 104-2, and 104-N can be computing devices and/or server devices, among other types of devices. Communication network 102 can also be communicatively coupled to local area network (LAN) 106. LAN 106 can be coupled to a data center network 108. The data center network 108 can be communicatively coupled to a business service management (BSM) component 110, a change management system 116, a configuration management database (CMDB) 118, and a change device 120. The data center network 108 can be used to schedule and implement changes to the components of network 102 and/or services operated on network 102. A communication network can also include a number of servers communicatively coupled to the communication network. Each system component can be coupled to network 102 by a wired or wireless communication channel.

In a network, services such as logging data, browsing data, and requesting data, among other services, can be requested by a user. These services can be completed by executing a number of transactions using components, such servers, on a computing network. A number of components can be included in a computing device that can have a number of resources. The component resources can be portions of a component that provide for the functional operation of the component. Component resources can include a number of processors, a number of network interfaces, a number of input/output (IO) interfaces, hard disk operation, and memory operation, among other component resources. The following discussion will be made in the context of a service that uses servers and computing devices to execute the service. However, examples of the present disclosure are not limited to these examples, and the system and method of the present disclosure may be implemented in many other configurations, and applied to many other services.

Examples of the present disclosure can include services such as logging data, browsing data, and requesting data, among other services. The services can be provided to the network 102 by a number of devices 104-1, 104-2, 104-N, when the number of devices are a number of servers on the network 102, and the services can be used by a number of devices 104-1, 104-2, 104-N, the number of devices are a number of computing devices on the network 102. The services can include a number of transactions. The transactions can include operations that are performed by components on a network to execute a service. A service can include any number of types of transactions and any number of each type of transaction. The type of the transaction and the number of each transaction type and/or rate of each transaction type that make up a service can be referred to as the transaction mix for a service.

The transaction mix for service includes a number of transactions and the transaction rate for each transaction type of a service. A service is completed by executing the transaction mix for the service on a number of components. The components can be servers on a network, such as a web server, an application server, a database server, and/or a computing device.

Generally, the number of devices 104-1, 104-2, and 104-N may include virtually any computing device capable of connecting to another computing device to send and receive information, including web requests for information from a server device, and the like.

The number of devices 104-1, 104-2, and 104-N may be a number of servers that can provide a number of services operated on the network 102. The number of devices 104-1, 104-2, and 104-N may further include a client application to manage various actions, for example, a web browser application to enable an end-user to interact with a number of servers and/or other devices and/or applications via network 102.

The BSM component 110 can include an end user management (EUM) and real user monitoring (RUM) component 112. The EUM-RUM component 112 can be used to monitor the network traffic for network 102. The EUM-RUM component 112 can use network probes to monitor and record the network traffic. The EUM-RUM component 112 can monitor and analyze RUM data. RUM data can include information regarding user traffic on a network and can include information about all transactions by all users that occur on a network. RUM data can be collected via non-obtrusive probes coupled to the network that can monitor and record information about the transaction occurring on the network 102. The EUM-RUM component 112 can monitor and record all user transactions on the network used to execute a service. The transactions can be associated with using a service on the network. The monitoring and recording of all user transaction can be used to analyze the performance of the network and to determine a usage pattern of the users using devices 104-1, 104-2, and 104-3 on the network 102. The usage pattern can include the quantity, type, and time of user transactions on the network. The monitoring and recording of all user transaction can include information about each transaction, such as the response time for the transaction, the availability of the network to perform the transaction, the number of transaction that occur over a time period, and/or the type of transaction, among other information. This information about each of the transactions can be stored in the EUM-RUM component 112.

The BSM component 110 can include baseline component 114. The baseline component 114 can use the information about each of the transactions can be stored in the EUM-RUM component 112 to learn the normal behavior of the user transactions. The baseline component 114 can determine the normal behavior of users on a network based on historical information about each of the transactions occurring on a network.

The CMDB 118 can include a database that manages the configuration items (Cis) for the services provided on the network 102. The CMBD 118 can include information regarding the features, settings, and/or status, among other information, for each service provided on the network 102. The CMBD 118 can manage, allocate, and store the configuration information for the services provided by the network 102.

The change device 120 can include a computing device that includes information regarding a change to the network 102. The change device 120 can send a change request to the change management system 116. The change management system 116 can be used to for scheduling changes to the network 102. The change management system 116 can request information from the CMDB 118 about the CIs that are affected by the changes in the change request. The change management system 116 can request information from the BSM component 110 regarding the usage pattern of the services affected by the changes in the changed request based on the information about the transactions by users on the network stored in the BSM 110. The change management system 116 can use the information about the CIs and the usage pattern to determine an appropriate window of time to implement the change. The window of time to implement the change based information about the CIs and the usage pattern can be during a time that reduces the negative impact of implementing the change on users using services provided on the network 102.

Not all of the components illustrated in FIG. 1A are required to practice the system and method of the present disclosure, and variations in the arrangement, type, and quantities of the components may be made without departing from the spirit or scope of the system and method of the present disclosure. Other computing network system components can include personal computers, laptop computers, mobile devices, cellular telephones, personal digital assistants, video game consoles, or the like. Communication channels may be similar to, or different from, other communication channels.

Servers in a network may include a server application to manage various actions, for example, a web-server application to enable an end-user to interact with servers via the network, e.g., network 102. In examples of the present disclosure, first second, and third user devices 104-1, 104-2, and 104-3 may complete a service, such as a computing service, by executing the transactions that make up a service.

In FIG. 1A, change device 120 includes a processor 121 and a non-transitory computer readable medium (CRM) 122 for executing instructions. First, second, and third user devices 104-1, 104-2, and 104-3 can include a number of processors and non-transitory computer-readable media (e.g., memory) that store instructions executable by the number of processors. That is, the executable instructions can be stored in a fixed tangible medium communicatively coupled to a number of processors. Memory can include RAM, ROM, and/or mass storage devices, such as a hard disk drive, tape drive, optical drive, solid state drive, and/or floppy disk drive.

The non-transitory computer readable media can be programmed with instructions such as an operating system for controlling the operation of servers, and/or computing services such as logging data, browsing data, and requesting data, among other services. The operating system and/or applications may be implemented as a number of executable instructions stored at a number of locations within volatile and/or non-volatile memory. Servers may also include an internal or external database, or other archive medium for storing, retrieving, organizing, and otherwise managing computing services.

A network, e.g., network 102, can include a mobile device that can also be a user device and include a processor in communication with a non-transitory memory, a power supply, a number of network interfaces, an audio interface, a video interface, a display, a keyboard and/or keypad, and an optional global positioning systems (GPS) receiver. A mobile device may optionally communicate with a base station (not shown), or directly with another network component device. Network interfaces include circuitry for coupling the mobile device to a number of networks, and is constructed for use with a number of communication protocols and technologies including, but not limited to, e-mail, Internet, and/or wireless communication protocols. The network interface is sometimes known as a transceiver, transceiving device, or network interface card (NIC).

Applications on user devices may include computer executable instructions stored in a non-transient medium which, when executed by a processor, provide functions, such as a web browser, to enable interaction with other computing devices such as a server, and/or the like.

In some examples, the above discussed computing network system can be used, controlled, and/or the like through a web browser by a user. In some examples, the web browser can communicate with a web server running server-side computing applications to perform computing services.

FIG. 1B is a block diagram illustrating an example of a computer readable medium (CRM) 122 in communication with processing resources 123. As used herein, processor resources 123 can include one or a plurality of processors 121 such as in a parallel processing arrangement. A computing device having processor resources can be in communication with, and/or receive a tangible non-transitory computer readable medium (CRM) 122 storing a set of computer readable instructions (e.g., software) for capturing and/or replaying network traffic, as described herein.

As used herein, the indefinite articles “a” and/or “an” can indicate one or more than one of the named object. Thus, for example, “a processor” can include one processor or more than one processor. Processor resources can also be control circuitry that can have a structure that provides a given functionality, and/or execute computer-readable instructions that are stored on an internal or external non-transitory computer-readable medium. Non-transitory computer-readable medium (e.g., computer readable medium 122), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital video discs (DVD), high definition digital versatile discs (HD DVD), compact discs (CD), and/or a solid state drive (SSD), flash memory, etc., as well as other types of machine-readable media.

The non-transitory computer-readable medium can be integral, or communicatively coupled, to a computing device, in either in a wired or wireless manner. For example, the non-transitory computer-readable medium can be an internal memory, a portable memory, a portable disk, or a memory located internal to another computing resource (e.g., enabling the computer-readable instructions to be downloaded over the Internet). The non-transitory computer-readable medium can have computer-readable instructions stored thereon that are executed by the processing resources (e.g., control circuitry, processor(s)) to provide a particular functionality.

The CRM 122 can be in communication with the processor 123 resources via a communication path 126. The communication path 126 can be local or remote to a machine associated with the processor resources 123. Examples of a local communication path 126 can include an electronic bus internal to a machine such as a computer where the CRM 122 is one of volatile, non-volatile, fixed, and/or removable storage medium in communication with the processor resources 123 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

In other examples, the communication path 126 can be such that the CRM 464 is remote from the processor resources 123 such as in the example of a network connection between the CRM 122 and the processor resources 123 (e.g., the communication path 126 can be a network connection). Examples of such a network connection can include a local area network (LAN), a wide area network (WAN), a personal area network (PAN), the Internet, among others. In such examples, the CRM 122 may be associated with a first computing device (e.g., a server) and the processor resources 123 may be associated with a second computing device (e.g., a client). The first and second computers can be in communication via a networked communication path 126.

Logic can be used to implement the method(s) of the present disclosure, in whole or part. Logic can be implemented using appropriately configured hardware and/or software. For example computers creating a configuration file template can include logic configured to present a base configuration file stored in memory in a window of a first pane of a user interface, identify a selection of a portion of the base configuration file that indicates a syntax element, define one or more parameters of the syntax element based on the selection, and present the defined descriptor associated with the selected syntax element in a second pane of the window. The above-mention logic portions may be discretely implemented and/or implemented in a common arrangement.

As used herein, the term “read-only” refers to a pane where contents of pane cannot be modified directly by the user. Read-only allows for user selectability by various methods, including highlighting displayed character elements.

FIG. 2 is a change scheduling relationship diagram illustrating components of a change scheduling system according to examples of the present disclosure. In FIG. 2, a change management system 116 can include inputs from user metrics 230, user transaction load 232, changes 238, and services 236. In FIG. 2, user metrics 230 can be recorded and analyzed by a business service management component. The user metrics 230 can include information about each transaction on a network, such as the response time for the transaction, the availability of the network to perform the transaction, the number of transaction that occur over a time period, and/or the type of transaction, among other information. The user metrics 230 can be used to determine the user transaction load 232. The user transaction load 232 identifies the type of transactions, the association between each transaction type and a number of services, and the rate at which transactions are requested by users and performed on the network. The user transaction load 232 can be used to determine the usage pattern of the services on a network and form a baseline of the services used by users on a network.

In FIG. 2, a change 238 can include changes to software, hardware, and/or components. For example, the change can be an update to a version of a computer program and/or application. In another example, the change can be upgrading a component, such as a server, on a computer network. A change 238 and a change request can be communicated to the change management system 216. The change management system 216 can received information regarding the services 236 that are affected by the change 238 from a CMDB.

The change management system 216 can receive a change request from a change device. A CMDB can detect a number of services affected by the change request and transfer this information to the change management system 216. The change management system 216 can extract usage patterns for the number of services from a baseline of service usage by a number of users and determine a window of time for implementing a change indicated by the change request based on the number of services affected by the change request and the usage pattern for the number of services. The change management system 216 can then schedule the change within the window for implementing the change. The change management system 216 can include a number of requirements illustrated in change policies for the change scheduling system. The requirements illustrated in the change policies can include requirements that a change does not interfere with other changes, a change can be completed within a time frame, and/or a change can be completed with the resource available, among other requirements, for example.

The window of time for implementing a change can be determined based on a number of factors. The window of time for implementing the change can be when the usage pattern indicates the transaction rate to be lower than other windows of time. The window of time can also incorporate factors such as a window of time for a change that affects the least amount of services that are performed on a network, a window of time for a change that affects the least amount of users on a network, and/or a window of time for a change that reduces revenue from services on a network the least amount and/or an acceptable amount.

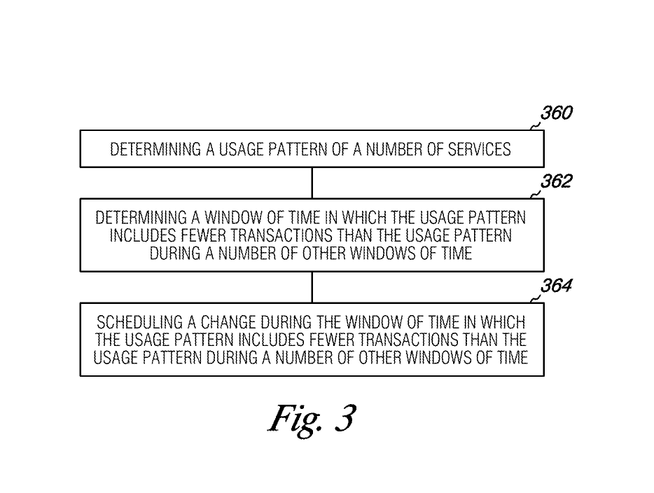

FIG. 3 is a method flow diagram illustrating change scheduling according to examples of the present disclosure. Scheduling a change can include determining a window of time for implementing the change impacts the services affected by the change in a minimal and/or acceptable manner. In FIG. 3, change scheduling includes determining a usage pattern of a number of services 360, determining a window of time in which the usage pattern includes fewer transactions than the usage pattern during a number of other windows of time 362, and scheduling a change during the window of time in which the usage pattern includes fewer transactions than the usage pattern during a number of other windows of time 364.

Change scheduling can further include determining a usage pattern of a number of services by collecting real user monitoring (RUM) data and determining usage patterns of a number of services by creating a baseline representing the usage pattern of the number of services for a time period. The method can also further include detecting a number of services affected by the change using a configuration management database and implementing the change during the window of time. Examples of the present disclosure can also include scheduling a change during the window of time in which the usage of the number of services is lower than during the number of other windows of time and also before a change implementation deadline.

The above specification, examples and data provide a description of the method and applications, and use of the system and method of the present disclosure. Since many examples can be made without departing from the spirit and scope of the system and method of the present disclosure, this specification merely sets forth some of the many possible configurations and implementations.

Although specific examples have been illustrated and described herein, those of ordinary skill in the art will appreciate that an arrangement calculated to achieve the same results can be substituted for the specific examples shown. This disclosure is intended to cover adaptations or variations of a number of examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the number of examples of the present disclosure includes other applications in which the above structures and methods are used. Therefore, the scope of number of examples of the present disclosure should be determined with reference to the appended claims, along with the full range of equivalents to which such claims are entitled.

Various examples of the system and method for scheduling changes have been described in detail with reference to the drawings, where like reference numerals represent like parts and assemblies throughout the several views. Reference to various examples does not limit the scope of the system and method for displaying advertisements, which is limited only by the scope of the claims attached hereto. Additionally, any examples set forth in this specification are not intended to be limiting and merely set forth some of the many possible examples for the claimed system and method for scheduling changes.

Throughout the specification and claims, the meanings identified below do not necessarily limit the terms, but merely provide illustrative examples for the terms. The meaning of “a,” “an,” and “the” includes plural reference, and the meaning of “in” includes “in” and “on.” The phrase “in an example,” as used herein does not necessarily refer to the same example, although it may.

In the foregoing Detailed Description, some features are grouped together in a single example for the purpose of streamlining the disclosure. This method of disclosure is not to be interpreted as reflecting an intention that the disclosed examples of the present disclosure have to use more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

What is claimed:

1. A method for scheduling changes, the method comprising:
determining a usage pattern of a number of services (104-1, 104-2, 104-N, 236);
determining a window of time in which the usage pattern includes fewer transactions than the usage pattern during a number of other windows of time (116, 216, 352); and
scheduling a change (238) during the window of time in which the usage pattern includes fewer transactions than the usage pattern during a number of other windows of time (116, 216, 354).

2. The method of claim 1, wherein determining the usage pattern of the number of services (104-1, 104-2, 104-N, 236) includes collecting and analyzing real user monitoring (RUM) data (110, 112, 114, 230, 232).

3. The method of claim 1, wherein determining the usage pattern of the number of services (104-1, 104-2, 104-N, 236) includes creating a baseline (114) representing the usage pattern of the number of services (104-1, 104-2, 104-N, 236) for a time period.

4. The method of claim 1, wherein the method further includes detecting a number of services (104-1, 104-2, 104-N, 236) affected by the change (238) using a configuration management database (118).

5. The method of claim 1, wherein the method further includes causing an implementation of the change (238) during the window of time.

6. The method of claim 1, wherein the window of time in which the usage pattern includes fewer transactions than the usage pattern during the number of other windows of time is before a change implementation deadline (116, 216, 352).

7. The method of claim 1, wherein the change (238) is an update to a computing network (102).

8. A non-transitory computer readable medium (122) having instructions stored thereon executable by a processor (121) to:
enter a change request to a change management system (116, 216);
detect a number of services (104-1, 104-2, 104-N, 236) affected by the change request using a configuration management database (118);
extract a usage pattern for the number of services (104-1, 104-2, 104-N, 236) from a baseline of service usage (114);
determine a window of time for implementing a change (238) indicated by the change request based on the number of services (104-1, 104-2, 104-N, 236) affected by the change request and the usage pattern for the number of services (104-1, 104-2, 104-N, 236); and
schedule the change (238) within the window of time for implementing the change (238).

9. The non-transitory computer readable medium (122) of claim 8, wherein the instructions stored thereon are executable by a processor (121) to cause an implementation of the change (238) within the window of time for implementing the change.

10. The non-transitory computer readable medium (122) of claim 8, wherein the window of time for implementing a change (238) includes a window of time where the usage pattern for the number of services (104-1, 104-2, 104-N, 236) indicates fewer users on the network (102) than other windows of time.

11. The non-transitory computer readable medium (122) of claim 8, wherein the usage pattern is based on real user monitoring (RUM) data (110, 112, 114, 230, 232).

12. A change scheduling system (116, 216), comprising:
at least one computing device having:
at least one processor (121); and
non-transitory computer readable memory (122) in communication with the at least one processor (121), the non-transitory computer readable memory (122) being programmed with instructions executable on the at least one processor (121) to:
determine a window of time in which to implement a change (238) based on a usage pattern for a number of services (104-1, 104-2, 104-N, 236) and a number of services (104-1, 104-2, 104-N, 236) affected by the change (238); and
schedule the change (238) during the window of time determined in which to implement the change (238).

13. The change scheduling system (116, 216) of claim 12, wherein the window of time in which to implement the change (238) meets the requirements of a number of change policies for the change scheduling system (116, 216).

14. The change scheduling system (116, 216) of claim 12, wherein the window of time in which to implement the change (238) minimizes the number of services (104-1, 104-2, 104-N, 236) affected by the implementation of the change (104-1, 104-2, 104-N, 236).

15. The change scheduling system (116, 216) of claim 12, wherein the usage pattern for the number of services includes creating a baseline (114) representing the usage pattern for the number of services (104-1, 104-2, 104-N, 236) for a time period.
